(19) United States
(12) Patent Application Publication
(10) Pub. No.: US 2024/0070634 A1
(43) Pub. Date: Feb. 29, 2024

(54) PAYMENT TRANSACTION PROCESSING SYSTEM FOR REDUCING INTERCHANGE COSTS

(71) Applicant: Maged Kerolos, Camarillo, CA (US)

(72) Inventor: Maged Kerolos, Camarillo, CA (US)

(21) Appl. No.: 18/243,019

(22) Filed: Sep. 6, 2023

Related U.S. Application Data
(63) Continuation of application No. 17/096,668, filed on Nov. 12, 2020, now abandoned.

(51) Int. Cl. G06Q 20/10; G06Q 20/20; G06Q 20/32; G06Q 30/0207

(52) U.S. Cl. CPC G06Q 20/108; G06Q 20/204; G06Q 20/3278; G06Q 30/0213

(57) ABSTRACT

A payment transaction processing system is described that involves separate instances of a payment transaction facilitation computer program running on the computing device or devices associated with a transaction processing entity, a consumer, and a merchant. The computer program facilitates a consumer's purchase of goods and/or services from a merchant at a physical store or online without incurring credit card or debit card interchanges fees. In one implementation, the transaction processing entity receives payment information from a consumer, or a merchant, or both. The payment amount is withdrawn from a bank account belonging to the consumer and deposited into a bank account belonging to the transaction processing entity. The payment amount less a transaction fee charged by the transaction processing entity is then withdrawn from the transaction processing entity's bank account and deposited into a bank account belonging to the merchant to complete the payment.

### CROSS REFERENCE TO RELATED APPLICATION

This application claims the benefit of and priority to U.S. patent application Ser. No. 17/096,668 filed Nov. 12, 2020.

### BACKGROUND

A bank is a financial institution licensed by a national government or central bank to receive deposits and offer checking account services, among other financial services to individuals and businesses. One of these other services involves transferring funds from one account to another account within the same bank. This type of transfer is called an intra-bank transfer and is typically performed without incurring a bank charge or fee. Inter-bank transfers are between different banks and can be facilitated by third party entities such as the Real-Time Payments (RTP)® network by The Clearing House Payments Company L.L.C. or the soon-to-be Federal Reserve's FedNow℠ service. There is typically a fee charged for interbank transfers.

Another financial service often offered by a bank (although not exclusively so) is the issuance of credit cards and/or debit cards. One aspect of the use of credit and debit cards relevant to the payment transaction processing system implementations described herein is an interchange fee. Credit card and debit card interchange rates are established by an Association (like Visa and MasterCard, Discover and American Express), and are generally paid by merchants (or other entities receiving payment via the credit/debit card) to the credit/debit card issuer on payment transactions conducted using the issued credit/debit card. Currently, one card issuer charges interchange fees that can be as high as 3.30% of the transaction amount plus a ten cent per transaction fee on some transaction depending on a myriad of factors such as whether the transaction is conducted online, via telephone, or in person.

### SUMMARY

The payment transaction processing system implementations described herein generally facilitate a payment transaction. One general implementation takes the form of a system that includes a payment transaction facilitator having one or more computing devices associated with a transaction processing entity, and a payment transaction facilitation computer program having a plurality of sub-programs executable by the computing device or devices. The sub-programs configure the computing device or devices to receive payment information from a payment transaction facilitation computer program running on a consumer's computing device, or a payment transaction facilitation computer program running on a merchant's computing device, or both. The payment information includes at least the consumer's identity, the merchant's identity and the payment for the goods or services being purchased by the consumer from the merchant. The sub-programs also configure the computing device or devices to withdraw an amount up to the amount of the payment from a bank account belonging to the consumer, and to deposit the withdrawn amount into a bank account belonging to the transaction processing entity. Still further, the sub-programs configure the computing device or devices to withdraw the payment amount less a transaction fee charged by the transaction processing entity from the transaction processing entity's bank account, and to deposit the payment amount less the transaction fee into a bank account belonging to the merchant.

Another general implementation takes the form of a system that includes a payment transaction facilitator having one or more computing devices associated with a transaction processing entity, and a payment transaction facilitation computer program having a plurality of sub-programs executable by the computing device or devices. The sub-programs configure the computing device or devices to receive payment information from a payment transaction facilitation computer program running on a consumer's computing device, or a payment transaction facilitation computer program running on a merchant's computing device, or both. The payment information includes at least the consumer's identity, the merchant's identity and the payment for the goods or services being purchased by the consumer from the merchant. The sub-programs also configure the computing device or devices to receive a notice from the payment transaction facilitation computer program running on a consumer's computing device that an amount up to the amount of the payment has been deposited into a bank account belonging to the transaction processing entity. Still further, the sub-programs configure the computing device or devices to withdraw the payment amount less a transaction fee charged by the transaction processing entity from the transaction processing entity's bank account, and to deposit the payment amount less the transaction fee into a bank account belonging to the merchant.

Yet another general implementation takes the form of a system that includes a payment transaction facilitator having one or more computing devices associated with a transaction processing entity, and a payment transaction facilitation computer program having a plurality of sub-programs executable by the computing device or devices. The sub-programs configure the computing device or devices to receive payment information from a payment transaction facilitation computer program running on a consumer's computing device. The payment information includes at least the consumer's identity, the merchant's identity and the payment for the goods or services being purchased by the consumer from the merchant. The sub-programs also configure the computing device or devices to withdraw the payment amount from a bank account belonging to the consumer at a bank where the transaction processing entity has a bank account, and to deposit the withdrawn payment amount into the transaction processing entity's bank account. This withdrawing and depositing of the payment amount being accomplished via an intrabank transfer system associated with the bank. The sub-programs further configure the computing device or devices to provide credit card information associated with the transaction processing entity, which pays the transaction processing entity all or part of an interchange fee paid by the merchant to the credit card issuer in connection with the purchase of goods or services, to the payment transaction facilitation computer program running on a consumer's computing device. The sub-programs also receive a notice from the payment transaction facilitation computer program running on the consumer's computing device indicating that the transaction processing entity's credit card information was provided to the merchant to purchase the goods or services for the payment amount and to withdraw the payment amount from the bank account belonging to the transaction processing entity and pay a credit card charge for the payment amount with the withdrawn funds.

Still another general implementation takes the form of a system that includes a transaction facilitator having one or more computing devices associated with a transaction processing entity, and a payment transaction facilitation computer program having a plurality of sub-programs executable by the computing device or devices. The sub-programs configure the computing device or devices to receive payment information from a payment transaction facilitation computer program running on a consumer's computing device, or a payment transaction facilitation computer program running on a merchant's computing device, or both. The payment information includes at least the consumer's identity, the merchant's identity and the payment for the goods or services being purchased by the consumer from the merchant. The sub-programs also configure the computing device or devices to determine if a prescribed amount up to the amount of the payment can be withdrawn from a bank account belonging to the consumer. Whenever the prescribed amount is not withdrawable from the consumer's bank, the sub-programs inform the consumer via the payment transaction facilitation computer program running on a consumer's computing device, and the merchant via the payment transaction facilitation computer program running on a merchant's computing device, that the goods or services being purchased by the consumer from the merchant cannot be purchased using the payment transaction facilitator. However, whenever the prescribed amount is withdrawable from the consumer's bank, the sub-programs withdraw an amount up to the amount of the payment from a bank account belonging to the consumer, deposit the withdrawn amount into a bank account belonging to the transaction processing entity, withdraw the payment amount less a transaction fee charged by the transaction processing entity from the transaction processing entity's bank account, and deposit the payment amount less the transaction fee into a bank account belonging to the merchant.

Still another general implementation takes the form of a system that includes a payment transaction facilitator having one or more computing devices associated with a transaction processing entity, and a payment transaction facilitation computer program having a plurality of sub-programs executable by the computing device or devices. The sub-programs configure the computing device or devices to receive payment information from a payment transaction facilitation computer program running on a consumer's computing device, or a payment transaction facilitation computer program running on a merchant's computing device, or both. The payment information includes at least the consumer's identity, the merchant's identity and the payment for the goods or services being purchased by the consumer from the merchant. The sub-programs also configure the computing device or devices to determine if the consumer and merchant involved in the payment transaction have an account at the same bank as the transaction processing entity. Whenever the consumer and merchant involved in the payment transaction do not both have an account at the same bank as the transaction processing entity, it is determined if fees associated with interbank transfer or transfers will exceed an estimated interchange fee typically charged for the same purchase using a credit or debit card, or will exceed a prescribed percentage of the estimated interchange fee associated with the purchase. Whenever it is determined that the interbank transfer fees will exceed the estimated interchange fee, or exceed the prescribed percentage of the estimated interchange fee, it is deemed that the sales transaction cannot be completed using the payment transaction facilitator, and the consumer is informed via the payment transaction facilitation computer program running on a consumer's computing device, and the merchant is informed via the payment transaction facilitation computer program running on a merchant's computing device, that the goods or services being purchased by the consumer from the merchant cannot be purchased using the payment transaction facilitator. However, whenever the consumer and merchant involved in the payment transaction do have an account at the same bank as the transaction processing entity, or whenever the consumer and merchant involved in the payment transaction do not both have an account at the same bank as the transaction processing entity but the interbank transfer fees will not exceed the estimated interchange fee, or not exceed the prescribed percentage of the estimated interchange fee, an amount up to the amount of the payment is withdrawn from a bank account belonging to the consumer, and the withdrawn amount is deposited into a bank account belonging to the transaction processing entity. Additionally, the payment amount less a transaction fee charged by the transaction processing entity is withdrawn from the transaction processing entity's bank account, and the payment amount less the transaction fee is deposited into a bank account belonging to the merchant.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the payment transaction processing system implementations described herein will become better understood with regard to the following description, appended claims, and accompanying drawings where:

FIG. 1 is a diagram illustrating one implementation, in simplified form, of a system framework for realizing the payment transaction processing system implementations described herein.

FIG. 2 is a diagram illustrating one implementation, in simplified form, of an alternate system framework for realizing the payment transaction processing system implementations described herein.

FIG. 3 is a diagram illustrating one implementation, in simplified form, of yet another alternate system framework for realizing the payment transaction processing system implementations described herein.

FIG. 4 is a flow diagram illustrating an exemplary implementation, in simplified form, of payment transaction facilitation computer program sub-programs for facilitating a consumer's purchase of goods and/or services from a merchant without incurring credit card or debit card interchanges fees where the transaction processing entity withdraws purchase funds from the consumer's bank account.

FIG. 5 is a flow diagram illustrating an exemplary implementation, in simplified form, of sub-programs of the payment transaction facilitation computer program for receiving payment information from a consumer's computing device and a merchant merchant's computing device.

FIG. 6 is a flow diagram illustrating an exemplary implementation, in simplified form, of sub-programs of the payment transaction facilitation computer program for receiving payment information from a consumer's computing device.

FIG. 7 is a flow diagram illustrating an exemplary implementation, in simplified form, of sub-programs of the payment transaction facilitation computer program for receiving payment information from a merchant's computing device.

FIG. 8 is a flow diagram illustrating an exemplary implementation, in simplified form, of payment transaction facilitation computer program sub-programs for facilitating a consumer's purchase of goods and/or services from a merchant without incurring credit card or debit card interchanges fees where the consumer pushes the purchase funds to the transaction processing entity's bank account.

FIGS. 9A-C are a flow diagram illustrating an exemplary implementation, in simplified form, of payment transaction facilitation computer program sub-programs for facilitating a consumer's purchase of goods and/or services from a merchant without incurring credit card or debit card interchanges fees where a delay in the deposit of the purchase funds into the merchant's bank account is anticipated.

FIG. 10 is a flow diagram illustrating an exemplary implementation, in simplified form, of payment transaction facilitation computer program sub-programs for paying an incentive award to the consumer.

FIGS. 11A-B are a flow diagram illustrating an exemplary implementation, in simplified form, of payment transaction facilitation computer program sub-programs for facilitating a consumer's purchase of goods and/or services from a merchant where the merchant does not have the payment transaction facilitation computer program.

FIG. 12 is a flow diagram illustrating an exemplary implementation, in simplified form, of payment transaction facilitation computer program sub-programs for determining if the consumer has sufficient funds in their bank account to cover the purchase funds required for the payment transaction.

FIGS. 13A-B are a flow diagram illustrating an exemplary implementation, in simplified form, of payment transaction facilitation computer program sub-programs for determining if interbank transfer fees exceed the estimated interchange fee (or a prescribed percentage thereof) typically charged for the same purchase using a credit or debit card.

FIG. 14 is a diagram illustrating a simplified example of a general-purpose computer system on which various implementations and elements of the payment transaction processing system, as described herein, may be realized.

### DETAILED DESCRIPTION

In the following description of payment transaction processing system implementations reference is made to the accompanying drawings which form a part hereof, and in which are shown, by way of illustration, specific implementations in which the payment transaction processing system can be practiced. It is understood that other implementations can be utilized, and structural changes can be made without departing from the scope of the payment transaction processing system implementations.

It is also noted that for the sake of clarity specific terminology will be resorted to in describing the payment transaction processing system implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “some implementations”, or “one tested implementation”; or “one version”, or “another version”, or an “exemplary version”, or an “alternate version”, or “some versions”, or “one tested version”; or “one variant”, or “another variant”, or an “exemplary variant”, or an “alternate variant”, or “some variants”, or “one tested variant”; means that a particular feature, a particular structure, or particular characteristics described in connection with the implementation/version/variant can be included in one or more implementations of the payment transaction processing system. The appearances of the phrases “in one implementation”, “in another implementation”, “in an exemplary implementation”, “in an alternate implementation”, “in some implementations”, “in one tested implementation”; “in one version”, “in another version”, “in an exemplary version”, “in an alternate version”, “in some versions”, “in one tested version”; “in one variant”, “in another variant”, “in an exemplary variant”, “in an alternate variant”, “in some variants” and “in one tested variant”; in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the payment transaction processing system does not inherently indicate any particular order nor imply any limitations of the payment transaction processing system.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive, in a manner similar to the term “comprising”, as an open transition word without precluding any additional or other elements.

### 1.0 Payment Transaction Processing System

In general, the payment transaction processing system implementations described herein involve the use of a payment transaction facilitator that employs one or more computing devices, and a payment transaction facilitation computer program having a plurality of sub-programs executable by the computing device or devices. Separate instances of the payment transaction facilitator and payment transaction facilitation computer program run on the computing device or devices associated with a transaction processing entity, one or more consumers, and in some implementations one or more merchants. The payment transaction facilitation computer program facilitates a consumer's purchase of goods or services from a merchant at a physical “brick and mortar” store or online without incurring the previously described credit card or debit card interchanges fees.

### 1.1 Payment Transaction Processing System Framework

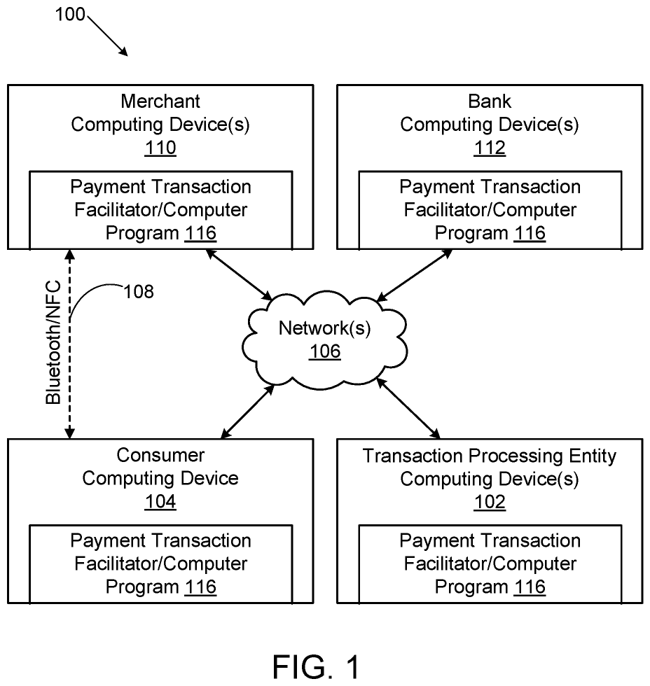

FIG. 1 illustrates an exemplary implementation, in simplified form, of a framework for realizing the payment transaction processing system implementations described herein. As exemplified in FIG. 1 the system framework 100 includes a transaction processing entity computing device or devices 102 associated with the transaction processing entity, which are used to coordinate the sale of goods and/or services between a consumer and a merchant. In an exemplary implementation of the payment transaction processing system described herein, the transaction processing entity computing device or devices 102 can be any type of conventional computing device(s) (including, but not limited to a desktop personal computer (PC) or a server, among other types of conventional computing devices). For example, when multiple devices are employed, the transaction processing entity computing devices 102 could be a server farm. The transaction processing entity computing device or devices 102 are configured to communicate over conventional data communication networks 106 such as the Internet (among other types of conventional communication networks and channels such as an intranet, cellular, phonelines, RF, etc.) with computing devices associated with banks, consumers and merchants. It is noted that different data communication networks can be employed when communicating with the various computing devices associated with banks, consumers, and merchants.

The system framework 100 also includes a consumer computing device 104 that is used by a consumer to purchase goods and/or services either in person at a “brick and mortar” store or online. In an exemplary implementation of the payment transaction processing system described herein the consumer computing device 104 can be any type of conventional mobile computing device (including, but not limited to the a smartphone, or a tablet computer, or a laptop computer (sometimes also referred to as a notebook or netbook computer), or a computing device that is integrated into an automobile, among other types of conventional mobile computing devices) or any type of conventional non-mobile computing device (including, but not limited to a desktop personal computer (PC) or a server, among other types of conventional non-mobile computing devices). The consumer computing device 104 is configured to communicate over conventional data communication networks 106 such as the Internet (among other types of conventional communication networks and channels such as an intranet, cellular, phonelines, RF, etc.) with computing devices associated with banks, the transaction processing entity, and merchants. It is noted that different data communication networks can be employed when communicating with the various computing devices associated with banks, the transaction processing entity, and merchants. For example, when a consumer is purchasing goods and/or services in person at a “brick and mortar” store, in one implementation, the consumer's computing device is in communication with the merchant's computing device via a proximity communication connection like Bluetooth or near-field communication (NFC). This optional connection is represented as a broken line 108 in FIG. 1.

The system framework 100 further includes a merchant computing device or devices 110 that is used by a merchant to sell goods and/or services either in person at a “brick and mortar” store (sometimes referred to as point of sale transactions) or online. In an exemplary implementation of the payment transaction processing system described herein the merchant computing device(s) 110 can be any type of conventional mobile or non-mobile computing device (including, but not limited to the types described heretofore, as well server farm). In one implementation, the merchant computing device 110 takes the form of a conventional payment terminal (similar to a conventional credit/debit card processing terminal currently found in physical stores and businesses or a merchant's handheld reader). The merchant computing device(s) 110 are configured to communicate over conventional data communication networks 106 such as the Internet (among other types of conventional communication networks and channels such as an intranet, cellular, phonelines, RF, etc.) with computing devices associated with banks, the transaction processing entity, and consumers. It is noted that different data communication networks can be employed when communicating with the various computing devices associated with banks, the transaction processing entity, and consumers. For example, when a merchant is selling goods and/or services in person at a “brick and mortar” store, in one implementation, the merchant's computing device is in communication with the consumer's computing device via a proximity communication connection like Bluetooth or near-field communication (NFC) 108.

Referring again to FIG. 1, the system framework 100 further includes a bank computing device or devices 112 associated with a bank. In an exemplary implementation of the payment transaction processing system described herein, the bank computing device or devices 112 can be any type of conventional computing device(s) (including, but not limited to the types described heretofore, as well server farm). The transaction processing entity computing device or devices 102 are configured to communicate over conventional data communication networks 106 such as the Internet (among other types of conventional communication networks and channels such as an intranet, cellular, phonelines, RF, etc.) with computing devices associated with the transaction processing entity, consumers and merchants. It is noted that different data communication networks can be employed when communicating with the various computing devices associated with transaction processing entity, consumers, and merchants. The bank computing device(s) are employed to transfer funds between financial institution accounts (hereinafter referred to as a bank account or just account) belonging to the transaction processing entity, consumer and merchant via the bank's intrabank or interbank transfer system.

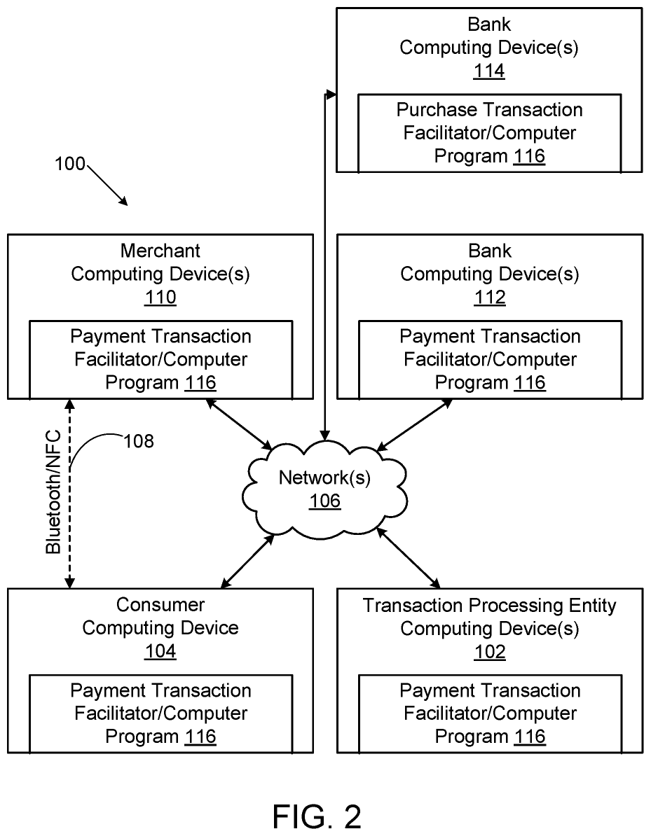

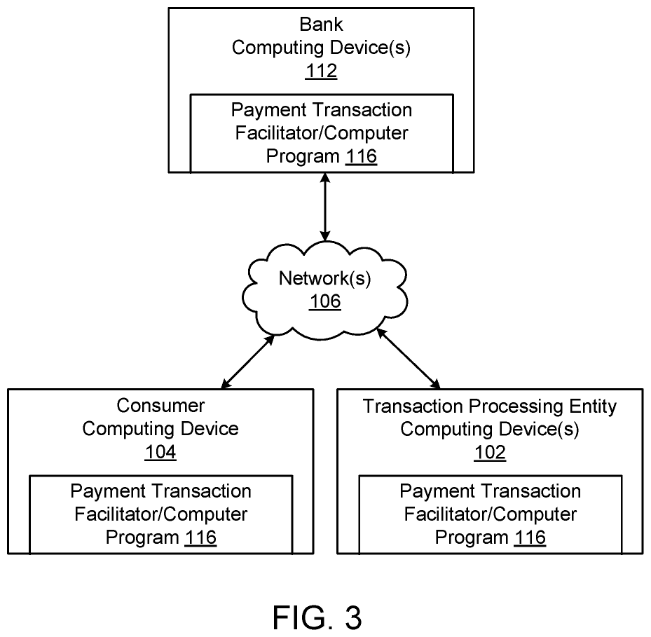

It is noted that the computing device(s) associated with a single consumer, a single merchant and a single bank are depicted in FIG. 1. This configuration applies to a single sales transaction where the transaction processing entity, consumer and merchant all have accounts at the same bank. However, from a more global perspective, the system framework can handle many sales transactions involving many different banks, merchants, and consumers. Still further, in implementations where interbank transfers are employed, there will be at least one additional bank 114 involved in a single sales transaction as shown in FIG. 2. Also, in implementations where the merchant does not have the payment transaction facilitation computer program (as will be described in greater detail in a later section), the system framework 100 lacks the merchant computing device(s) as shown in FIG. 3.

As indicated previously, the computing device(s) 102, 104, 110 associated with the transaction processing entity, the consumer, and the merchant, respectively, in FIG. 1 each include an instance 116 of the payment transaction facilitator and payment transaction facilitation computer program. The payment transaction facilitation computer program will be discussed in greater detail in the paragraphs to follow. It is also noted that for the sake of convenience in the description to follow, the computing devices associated with the transaction processing entity, the consumer, and the merchant, respectively, whether being multiple computing devices or just one, will be referred to generically in the singular as a computing device.

### 1.2 Payment Transaction Facilitation Computer Program

Consumers obtain the payment transaction facilitation computer program from the transaction processing entity. In one implementation, the consumer visits a website belonging to the transaction processing entity. The consumer then provides access to their bank account or accounts (which will likely be at one of the banks the transaction process entity has an account with) as part of obtaining the program. Once approved, the payment transaction facilitation computer program is provided to the consumer for download on the consumer's computing device. It is noted that the type of information required of the consumer to obtain the program, as well as the security measures employed to ensure the confidentiality of the consumer's identity and information, are conventional and adopted for this invention. The merchant also obtains the payment transaction facilitation computer program from the transaction processing entity. In one implementation, the merchant visits a website belonging to the transaction processing entity. The merchant may be invited to visit the site by the transaction processing entity or visit on their own. The merchant then provides the necessary information to allow the transaction processing entity to deposit funds into their bank account (which is likely to be at one of the banks the transaction process entity has an account with) as part of obtaining the program. Once approved, the payment transaction facilitation computer program is provided to the merchant for download on the merchant's computing device. It is noted that the type of information provided by the merchant to obtain the program, as well as the security measures employed to ensure the confidentiality of the merchant's identity and information, are conventional and adopted for this invention.

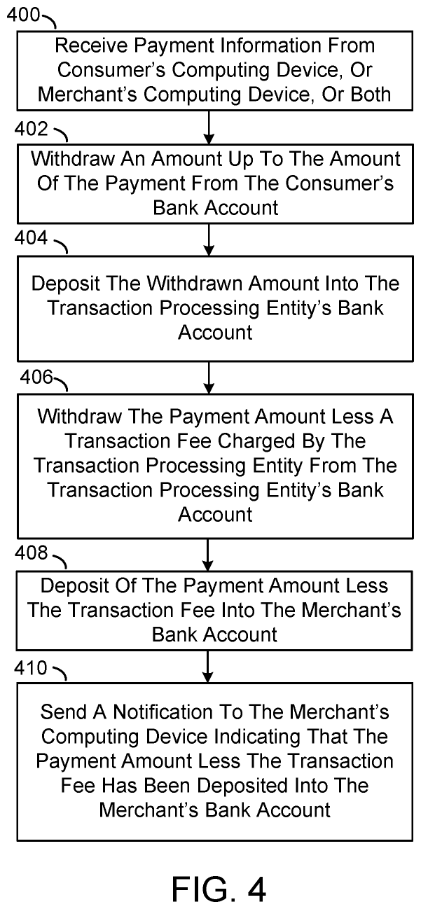

A consumer generally purchases goods and/or services from a merchant either at a physical location or online via a computer network. The initiation of a connection between the payment transaction facilitation computer programs running on the consumer's and the merchant's computing devices, as well as between the transaction processing entity's and bank's computing devices, is accomplished in a conventional manner. For example, at a physical location, a handshake protocol between the consumer's computing device and the merchant's computing device might be initiated by the consumer initiating the payment transaction facilitation computer program on their device, which then searches for and initiates communication with the merchant's device via a computer network or via a proximity-type connection, as described previously. It would even be possible for the handshake to be accomplished by the consumer's computing device displaying a QR code or another token which is read by a visual scanner on the merchant's computing device (or vice versa). In an online purchase setting, the handshake might be accomplished by a consumer selecting an icon displayed on a payment page of the merchant's website where the icon represents the payment transaction processing system. Once communication has been established between the various payment transaction facilitation computer programs involved in the payment transaction, the purchase can be achieved as follows. FIG. 4 illustrates one implementation, in simplified form, of sub-programs included in the payment transaction facilitation computer program that configure the aforementioned computing device associated with the transaction processing entity. More particularly, a payment information sub-program 400 is included as shown in FIG. 4. The payment information sub-program 400 receives payment information from the payment transaction facilitation computer program running on the consumer's computing device, or the merchant payment transaction facilitation computer program running on the merchant's computing device, or both. In one implementation, the payment information includes at least the consumer's identity, the merchant's identity and the payment for the goods or services being purchased by the consumer from the merchant. However, in other implementations, the payment information can include additional items such as the type of merchandise being bought, and so on. It is noted that for the purposes of this description, the term consumer identity can refer to any identifying information including for example one or more of the consumer's name or code name, virtual token, account number, another uniquely assigned number, and so on. Similarly, for the purposes of this description, the term merchant identity can refer to any identifying information including for example one or more of the merchant's consumer's name or code name, virtual token, account number, another uniquely assigned number, and so on. It is further noted that for the purposes of this description. A payment can take the form of anything of value including money, digital currencies such as cryptocurrencies, virtual currencies, central bank digital currencies and e-Cash, vouchers, gift cards, and so on. A payment withdrawal sub-program 402 associated with the payment transaction facilitation computer program running on the transaction processing entity's computing device is then employed to coordinate the withdrawal of an amount up to the amount of the payment from a bank account belonging to the consumer, and a payment deposit sub-program 404 is employed to coordinate the deposit of the withdrawn amount into a bank account belonging to the transaction processing entity. It is noted that reference to a consumer's bank account in this description can also mean multiple bank accounts should the consumer want to use more than one account. The withdrawn amount is the payment amount unless, as in one implementation, a consumer incentive award is held back so that an amount less than the payment is withdrawn. This incentive award implementation will be described in greater detail in a subsequent section. Next, a payment amount less transaction fee withdrawal sub-program 406 associated with the payment transaction facilitation computer program running on the transaction processing entity's computing device is employed to coordinate the withdrawal of the payment amount less a transaction fee charged by the transaction processing entity (e.g., half the amount of the interchange fee associated with a corresponding credit or debit card transaction) from the transaction processing entity's bank account, and a payment amount less transaction fee deposit sub-program 408 is employed to coordinate the deposit of the payment amount less the transaction fee into a bank account belonging to the merchant. In one version, once the payment amount less the transaction fee has been deposited into the merchant's bank account, a deposit notification sub-program 410 associated with the payment transaction facilitation computer program running on the transaction processing entity's computing device sends a notification to the merchant's computing device indicating that the payment amount less the transaction fee has been deposited into the merchant's bank account. This notification allows the merchant to complete the purchase process with the confidence that the purchase funds have been paid and so provide the goods and/or services to the consumer without risking non-payment.

A primary advantage of the payment transaction processing system implementations is that the interchange fees typically incurred by the merchant in a credit or debit card transaction are completely bypassed. In the foregoing system implementations, there is a fee charged to the merchant by the transaction processing entity for facilitating the sales transaction. However, this transaction fee can be made significantly less than the typical interchange fee associated with a corresponding credit or debit card transaction. The fee can be made less because the transaction processing entity can take advantage of the fee-free intrabank transfer systems offered by most banks. To this end, in one implementation, the transaction processing entity has accounts at a number of banks with the aim of having an account at either the bank where the consumer has an account, or the bank where the merchant has an account, or both. This is quite feasible because the transaction processing entity can set up bank accounts at a number of different banks. For example, the transaction processing entity could open accounts at the top 200 banks. It is believed that the top 200 banks handle a large percentage of the credit and debit card transactions. Thus, it would be likely that the transaction processing entity would have an account at the same bank as the consumer, or merchant, and probably both. As such, in various implementations of the payment transaction processing system, the previously described withdrawals and deposits are accomplished using fee-free intrabank transfer systems. In situations where the consumer, or merchant, or both, do not have bank accounts at the same bank as the transaction processing entity, the interbank transfer system can be employed as will be described in more detail in a section to follow.

In cases where the transaction processing entity, merchant and consumer all have accounts at the same bank, using the fee-free (or reduced or low fees) intrabank transfer system has the added advantage that the sales transaction ca happen very fast—in fact almost immediately from the perspective of the consumer and merchant involved in the sales transaction. Thus, the merchant can confirm that the funds from the sales transaction have been deposited before providing the goods and/or services to the consumer. This nearly immediate payment advantage is not available in a typical credit card or debit card sales transaction. Any risk to the merchant that they may not be paid for the goods or services they are providing to the consumer is also eliminated by the nearly immediate payment of the sales transaction funds. Another advantage of the payment transaction processing system implementations described herein to a merchant is the elimination of the costs associated with a refund. A chargeback is an amount that is returned to a debit or credit card, after a customer successfully disputes the transaction (or as defined by the card association). This amount (e.g., the amount of the original purchase payment) is transferred from the merchant's account to the cardholder's account at the issuing bank. The merchant is typically charged a fee by their credit card processing entity. The advantage to the merchant in using the payment transaction processing system implementations described herein is that any dispute is handled outside the credit/debit card system. As such no chargeback fees are incurred by the merchant. The consumer also benefits as they receive the goods and/or services without delay. In the case of an in-person sales transaction in a physical store or office, the consumer could receive the goods or services before leaving the premises. In the case of an online purchase, the goods or services can be scheduled for delivery or performance without any wait time to ensure payment. Still further, the speed of the sales transaction benefits the transaction processing entity as well. Since the fees earned for handling the transaction are deducted from the amount deposited in the merchant's bank account, the transaction processing entity is compensated immediately while the sales transaction is occurring. These fees are also earned risk free because the transaction processing entity is not required to “front” the payment to the merchant. Rather, the funds transferred from the consumer's bank account in association with the sale transaction are already in the transaction processing entity account.

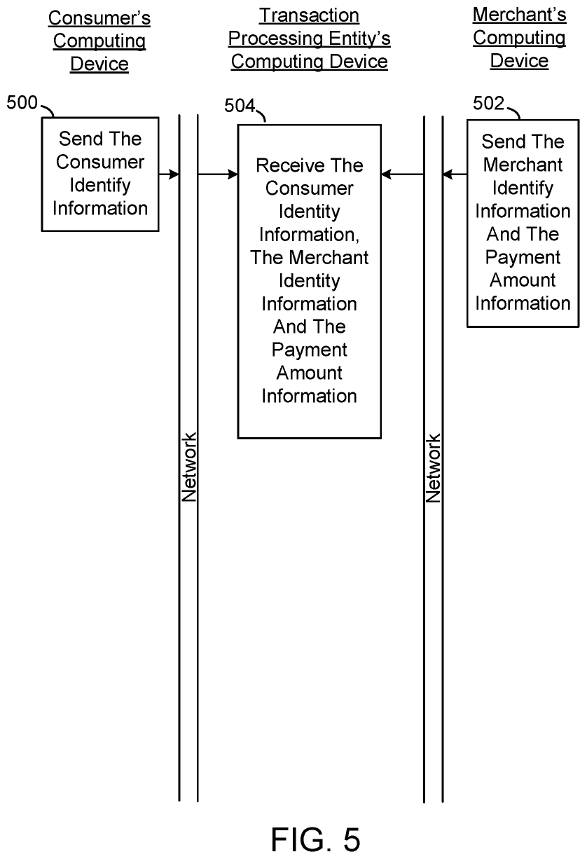

As described previously, payment information is received by the transaction processing entity's computing device from the payment transaction facilitation computer program running on the consumer's computing device, or the payment transaction facilitation computer program running on a merchant's computing device, or both. In one implementation where the payment information is received from both the consumer and merchant, referring to FIG. 5, a consumer's sales information sub-program 500 causes the consumer's computing device to send the consumer identify information to the transaction processing entity's computing device. Additionally, a merchant's sales information sub-program 502 causes the merchant's computing device to send the merchant identify information and the purchasing price information to the transaction processing entity's computing device. A payment information receiving sub-program 504 associated with the instance of the payment transaction facilitation computer program running on the transaction processing entity's computing device receives the consumer identity information from the consumer's computing device, and receives the merchant identity information and the purchasing price information form the merchant's computing device.

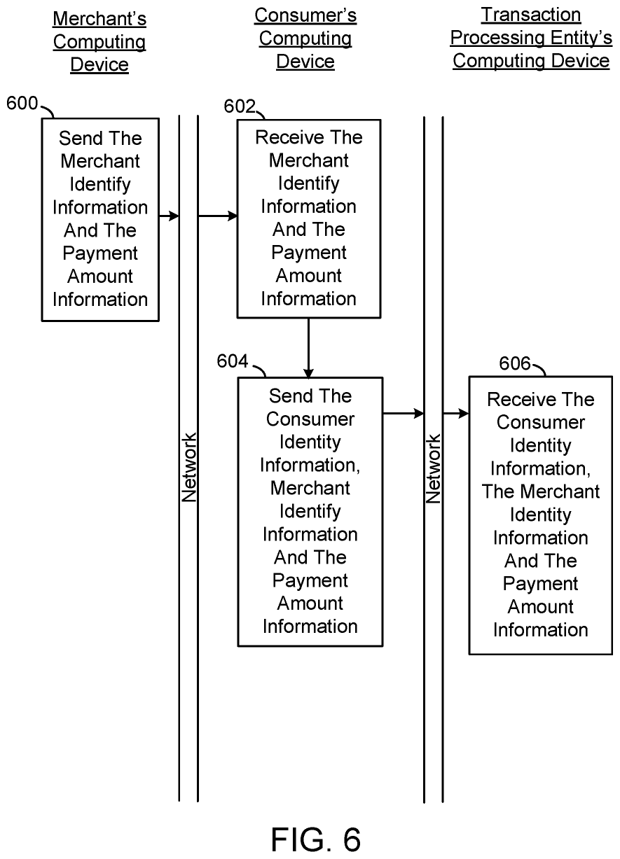

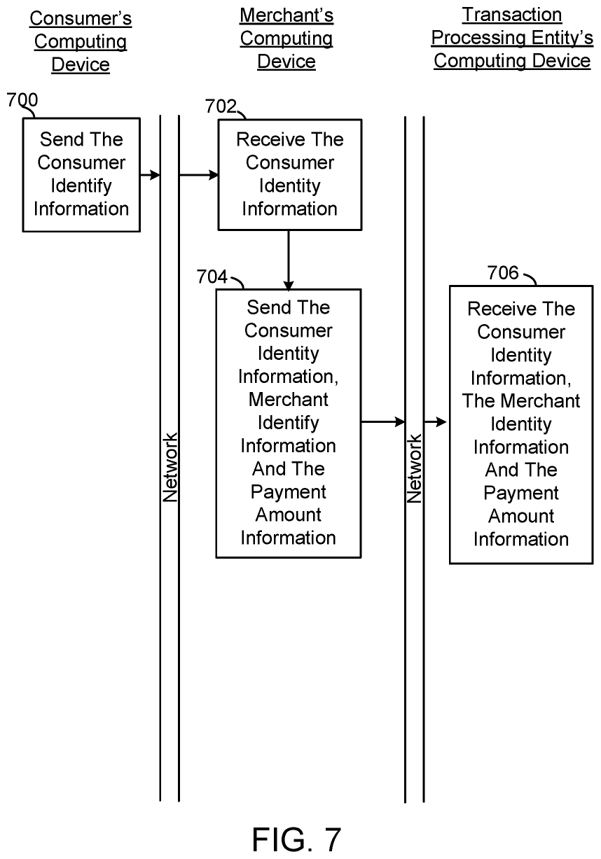

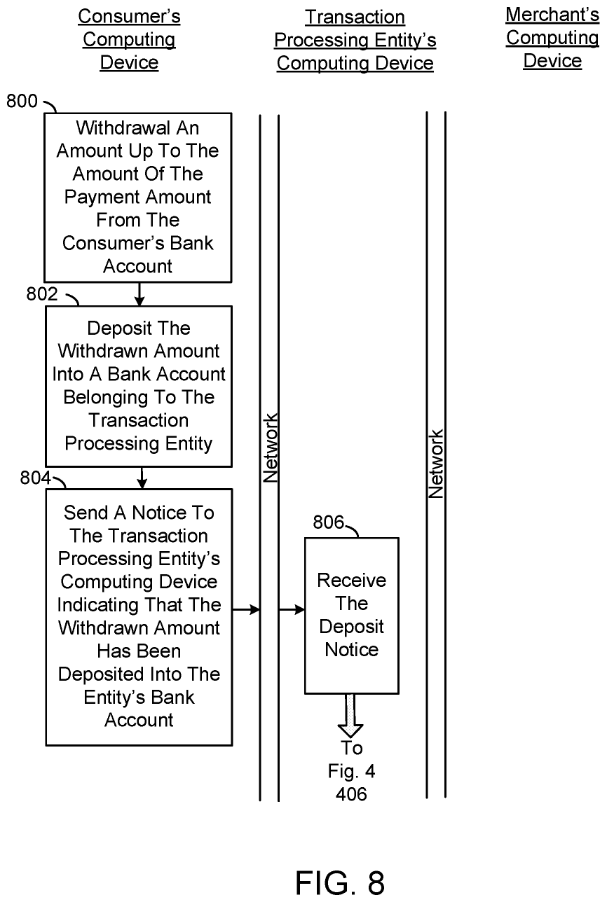

Alternate implementations for providing payment information to the transaction processing entity involve either the payment transaction facilitation computer program running on the merchant's computing device providing information to the payment transaction facilitation computer program running on the consumer's computing device, or vice versa. The computing device receiving the payment information from the other's computing device then send this information along with their own to the transaction processing entity's computing device. More particularly, in an alternate implementation where the payment information is received from the consumer, referring to FIG. 6, a merchant sales information sending sub-program 600 associated with the instance of the payment transaction facilitation computer program running on the merchant's computing device causes the merchant's computing device to send the merchant identify information and the purchasing price information to the consumer's computing device. A merchant payment information receiving sub-program 602 associated with the instance of the payment transaction facilitation computer program running on the consumer's computing device receives the merchant identify information and the purchasing price information, and a payment information sending sub-program 604 associated with the instance of the payment transaction facilitation computer program running on the consumer's computing device sends the consumer identity information, merchant identity information and purchasing price information to the transaction processing entity's computing device. A payment information receiving sub-program 606 associated with the instance of the payment transaction facilitation computer program running on the transaction processing entity's computing device receives the consumer identity information, merchant identity information and purchasing price information from the consumer's computing device. In an alternate implementation where the payment information is received from the merchant, referring to FIG. 7, a consumer payment information sending sub-program 700 associated with the instance of the payment transaction facilitation computer program running on the consumer's computing device causes the consumer's computing device to send the consumer identify information to the merchant's computing device. A consumer payment information receiving sub-program 702 associated with the instance of the payment transaction facilitation computer program running on the merchant's computing device receives the consumer identity information, and a payment information sending sub-program 704 associated with the instance of the payment transaction facilitation computer program running on the merchant's computing device sends the consumer identity information, merchant identity information and payment information to the transaction processing entity's computing device. A payment information receiving sub-program 706 associated with the instance of the payment transaction facilitation computer program running on the transaction processing entity's computing device receives the consumer identity information, merchant identity information and payment information from the merchant's computing device.

### 1.2.1 Pushing The Payment Amount

An alternate implementation of the payment transaction processing system operates in the same manner except that instead to the payment transaction facilitation computer program running of the transaction processing entity's computing device pulling funds from the consumer's bank account, the instance of the payment transaction facilitation computer program running of the consumer's computing device pushes the payment amount (or an amount less than the payment amount as will be explained in more detail later) from the consumer's bank account to the transaction processing entity's bank account. More particularly, in one version, the consumer adds the transaction processing entity's account as an authorized payee on their bank account ahead of time using the bank's existing intrabank transfer system. Then, when the consumer purchases goods and/or services using the payment transaction facilitation computer program running on their computing device, as part of the process, the program causes the required funds to be transferred to the transaction processing entity's bank account. In operation, this involves the consumer having designated the transaction processing entity as a beneficiary (i.e., payee), thus authorizing payment to the entity's bank account, during the setup of the payment transaction facilitation computer program on the consumer's computing device. The payment transaction facilitation computer program running on the consumer's computing device can then initiate a transfer of the required funds from the consumer's bank account to the pre-designated transaction processing entity's bank account.

More particularly, referring to FIG. 8, a payment withdrawal sub-program 800 associated with the payment transaction facilitation computer program running on the consumer's computing device is then employed to coordinate the withdrawal an amount up to the amount of the payment from the consumer's bank account, and a payment deposit sub-program 802 is employed to coordinate the deposit of the withdrawn amount into a bank account belonging to the transaction processing entity. The withdrawn amount is the payment amount unless, as in one implementation, a consumer incentive award is held back so that an amount less than the payment amount is withdrawn. This incentive award implementation will be described in greater detail in a subsequent section. A payment deposit notification sub-program 804 next sends a notification from the consumer's computing device to the transaction processing entity's computing device indicating that the aforementioned amount up to the amount of the payment has been deposited into the entity's bank account. A payment deposit notice receipt sub-program 806 associated with the payment transaction facilitation computer program running on the transaction processing entity's computing device receives the payment deposit notice, and the remainder of the procedure is as described in connection with FIG. 4 starting with the payment less transaction fee withdrawal sub-program 406.

### 1.2.2 Second Parallel Payment Method

Merchants have long accepted credit and debit card as forms of payment for goods and services and may be hesitant to embrace the payment transaction processing system implementations described herein. Thus, in one implementation of the payment transaction processing system, a second parallel payment method is employed to alleviate any concerns a merchant may harbor. In general, the parallel payment method involves the consumer providing a credit or debit card account number as an alternate form of payment. In a typical credit card purchase scenario, the issuing bank places an immediate hold (via communication with the merchant) for the sale amount on the consumer's credit or debit card. If the amount does not exceed the consumer's available credit limit and other conventional approval criteria, then the sale is approved, and the payment amount is reserved against the consumer′ credit. The merchant then submits the transaction amount for settlement along with any other unsubmitted transactions associated with the financial institution that issued the consumer's credit card. Eventually, the financial institution transfers the transaction amounts presented for settlement to the merchant. There are typically limits on the amount of time the credit hold can be enforced before the merchant is required to request settlement (e.g., 30 days). A somewhat simpler process is employed when a debit card is used to purchase goods or services. Given the foregoing scenarios, the purchase of goods and/or services with a credit or debit card as an alternate form of payment can be employed in any situation where payment using the payment transaction processing system is also employed. In one version, once the purchase funds are transferred to the merchant's bank account, the merchant can let the credit card hold expire or void it before it is submitted for settlement. In this way any perceived risk to the merchant is alleviated since the merchant can complete the credit card transaction if the purchase funds are not transferred into their bank account within a reasonable amount of time. The foregoing scenario is of particular advantage in situations where the transfer of funds from the consumer's bank account to the transaction processing entity's account, or from the transaction processing entity's account to the merchant's bank account, or both, are not immediate. For example, this may occur where one or more interbank transfers are employed, and these transfer(s) cause a delay. It could further be employed in the case of a slow intrabank transfer. For example, some banks impose a one-day delay in their intrabank transfers. As such, the merchant may have to provide the goods and/or services to the consumer without immediate payment, thus introducing a perceived risk the merchant may not be willing to accept.

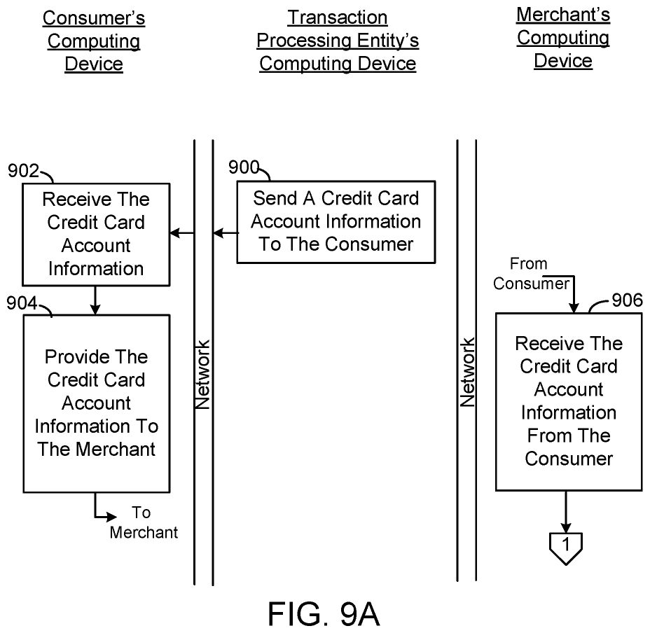

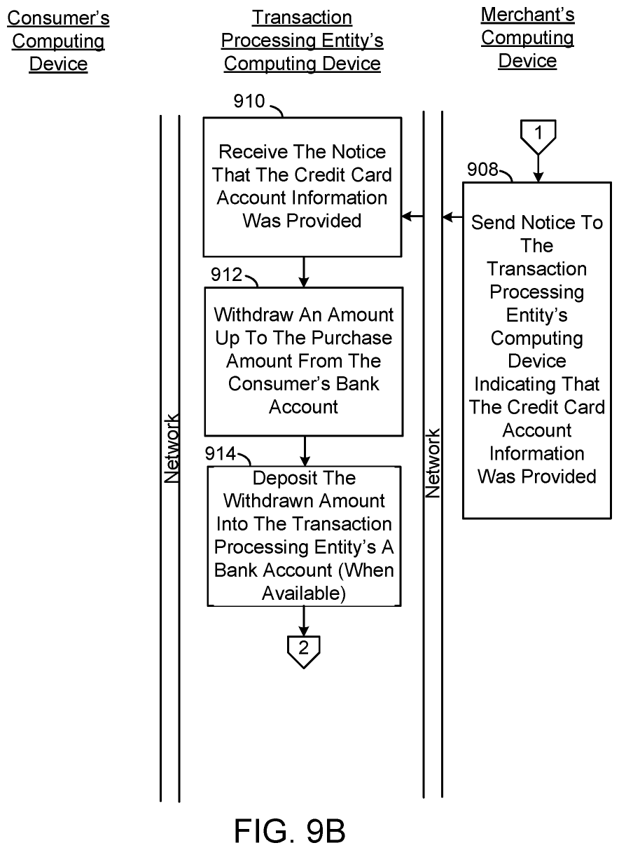

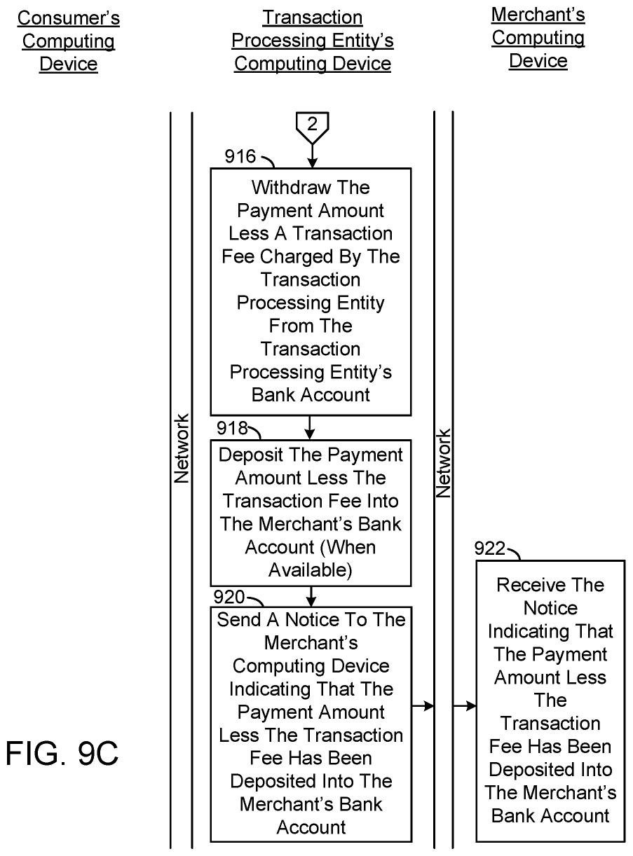

More particularly, referring to FIGS. 9A-C, in one implementation a second parallel payment option can be realized as follows. An alternate payment option credit card sub-program 900 associated with the payment transaction facilitation computer program running on the transaction processing entity's computing device sends credit card account information to the payment transaction facilitation computer program running on the consumer's computing device which includes a receipt sub-program 902 that receives the credit card account information. It is noted that for the purposes of this description, credit card account information can take the form of an actual credit card number sequence, or a randomly-generated and temporary virtual credit card number assigned in place of the actual card number, or a QR code or other token representing the actual card number, and so on. An alternate payment option credit card number submission sub-program 904 associated with the payment transaction facilitation computer program running on the consumer's computing device is then used in the conventional manner to provide the credit card account information to the merchant. An alternate payment option credit card receipt sub-program 906 associated with the payment transaction facilitation computer program running on the merchant's computing device receives the credit card account information (and employs it as described previously), and then employs a credit card receipt notice sub-program 908 to send a notification to the transaction processing entity's computing device indicating that the credit card account information was provided. Next, a notice receipt sub-program 910 associated with the payment transaction facilitation computer program running on the transaction processing entity's computing device receives the notification indicating that the credit card account information was provided to the merchant. A payment withdrawal sub-program 912 is then employed to coordinate the withdrawal an amount up to the amount of the payment from a bank account belonging to the consumer, and a payment deposit sub-program 914 is employed to coordinate the deposit of the withdrawn amount into a bank account belonging to the transaction processing entity. Next, once the amount up to the amount of the payment has been deposited into the transaction processing entity's bank account, a payment amount less transaction fee withdrawal sub-program 916 is employed to coordinate the withdrawal of the payment amount less a transaction fee charged by the transaction processing entity from the transaction processing entity's bank account, and a payment less transaction fee deposit sub-program 918 is employed to coordinate the deposit of the payment amount less the transaction fee into a bank account belonging to the merchant. Once the payment amount less the transaction fee has been deposited into the merchant's bank account, a deposit notification sub-program 920 sends a notification from the transaction processing entity's computing device to the merchant's computing device indicating that the payment amount less the transaction fee has been deposited into the merchant's bank account. A deposit notice receipt sub-program 922 associated with the payment transaction facilitation computer program running on the merchant's computing device receives the notification indicating that the payment amount less the transaction fee has been deposited into the merchant's bank account. The merchant can then let the aforementioned credit hold expire or void it without proceeding to settlement.

It is further noted that the payment transaction processing system implementations described herein can be employed in a situation where a credit card purchase has already been initiated but not yet settled, or even where the credit card purchase has been completed and settled. As described previously there are several advantages to the merchant that are realized when the payment transaction processing system implementations described herein are employed. Thus, there is an incentive for a merchant to void an unsettled credit card charge or go through the standard refund procedure if the charge is already settled, and then employ the payment transaction processing system implementations described herein instead. The transaction processing entity might offer an incentive to the merchant to make redoing the payment transaction even more enticing.

### 1.2.3 Consumer Incentive Award

In one implementation of the payment transaction processing system, the transaction processing entity or the merchant (or both) can also provide an incentive to the consumer to purchase goods and service using their payment transaction facilitation computer program by providing a reward. For example, once a transaction is complete and the purchase funds (less fees) are transferred to the merchant, the payment transaction facilitation computer program running on the transaction processing entity's computing device can transfer an incentive award amount (e.g., a set amount, or a percent of the payment amount, or so on) to the consumer's bank account. Alternatively, the payment transaction facilitation computer program running on the consumer's computing device could transfer the payment less the incentive award amount to the transaction processing entity's bank account, thus providing the award to the consumer in the form of a discounted payment. In either scenario, the transaction processing entity either proceeds as described previously and so bears the cost of the incentive award, or the payment transaction facilitation computer program running on the entity's computing device could add the cost of the award (or a part thereof) to the fee withheld from the payment amount transferred to the merchant. In this way the merchant bears all or some of the cost of the incentive award.

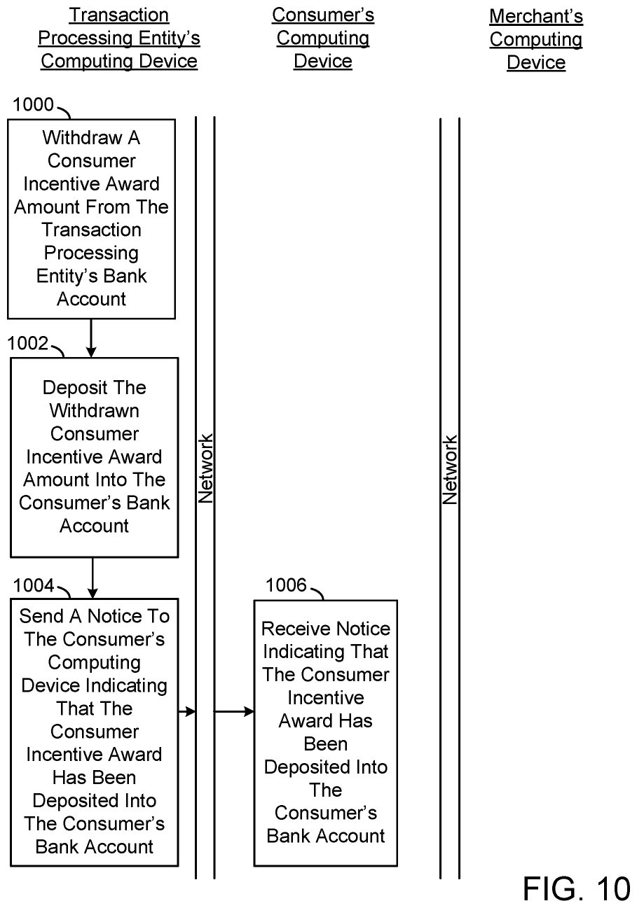

More particularly, in one implementation illustrated in FIG. 10, once the payment amount less the transaction fee has been deposited into the merchant's bank account and a deposit notification has been sent from the transaction processing entity's computing device to the merchant's computing device (e.g., 408 in FIG. 4 or 928 in FIG. 9), a consumer incentive award withdrawal sub-program 1000 associated with the payment transaction facilitation computer program running on the transaction processing entity's computing device withdraws a consumer incentive award amount from the transaction processing entity's bank account. A consumer incentive award deposit sub-program 1002 then deposits the withdrawn consumer incentive award amount into the consumer's bank account. Once the consumer incentive award has been deposited into the consumer's bank account, an award deposit notification sub-program 1004 associated with the payment transaction facilitation computer program running on the transaction processing entity's computing device sends a notification to the consumer's computing device indicating that the consumer incentive award has been deposited into the consumer's bank account. An award notice receipt sub-program 1006 associated with the payment transaction facilitation computer program running on the consumer's computing device then receives the notification indicating that the consumer incentive award has been deposited into the consumer's bank account. It is noted that in the foregoing procedure, it is assumed the full payment was withdrawn from the consumer's bank account.

In an alternate implementation, rather than the transaction processing entity depositing the consumer incentive award in the consumer's bank account, the previously described payment withdrawal sub-program (e.g., 402 in FIG. 4) associated with the payment transaction facilitation computer program running on the transaction processing entity's computing device could withdraw the payment amount less the incentive award amount from the consumer's bank account and deposit the withdrawn amount into the transaction processing entity's bank account (e.g., 404 in FIG. 4). In another alternate implementation, the previously described push-based payment withdrawal sub-program (e.g., 918 in FIG. 9) associated with the payment transaction facilitation computer program running on the consumer's computing device could withdraw the payment amount less the incentive award amount from the consumer's bank account and deposit the withdrawn amount into the transaction processing entity's bank account (e.g., 920 in FIG. 9).

If the merchant is to pay all or part of the cost of the consumer incentive award provided to the consumer via the foregoing procedures, then in one implementation, the previously described payment amount less transaction fee withdrawal sub-program (e.g., 406 in FIG. 4 or 922 in FIG. 9) associated with the payment transaction facilitation computer program running on the transaction processing entity's computing device could withdraw the payment amount less the transaction fee and less the merchant's prescribed portion of the consumer incentive award incentive award amount from the transaction processing entity's bank account and deposit the withdrawn amount into the merchant's bank account (e.g., 408 in FIG. 4 or 924 in FIG. 9).

### 1.2.4 Non-Participating Merchant

In one implementation of the payment transaction processing system, the previously described operations are modified to complete payment transactions in situations where the merchant does not have the payment transaction facilitation computer program running on their computing device. Assuming the applicable regulations allow it, the transaction processing entity owns, or is associated with, or has a fee sharing agreement with, a credit card issuing financial institution. A credit card account is issued in the name of the transaction processing entity. When a consumer wants to purchase goods or services from a merchant who does not have the payment transaction facilitation computer program running on their computing device, the payment amount (less any incentive award amount if applicable) is withdrawn from the consumer's bank account and deposited in the transaction processing entity's account as described previously, and the consumer's payment transaction facilitation computer program running on the consumer's computing device also provides the transaction processing entity's credit card information (such as the credit card number, or a virtual number, or a token, among other data) to the merchant (such as via the Internet when the transaction is being conducted online, or via the consumer's mobile computing device if the consumer is on-site). The merchant charges the credit card account in the normal manner and as a result pays the applicable interchange fee to the credit card issuer. The transaction processing company pays the credit card charge with the funds withdrawn from the consumer's bank account and then gets all or part of the interchange fee from the financial institution under a separate agreement.

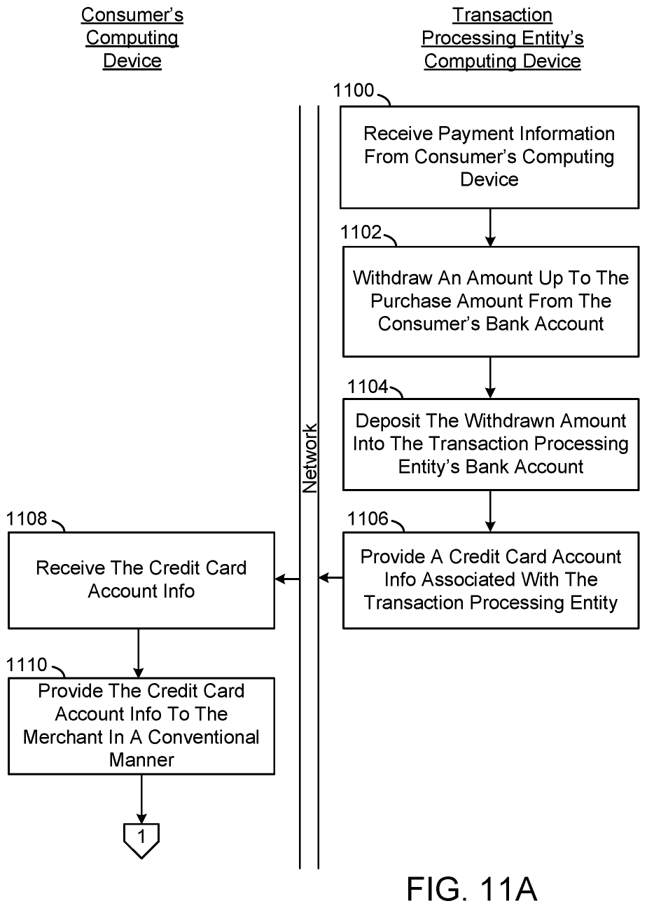

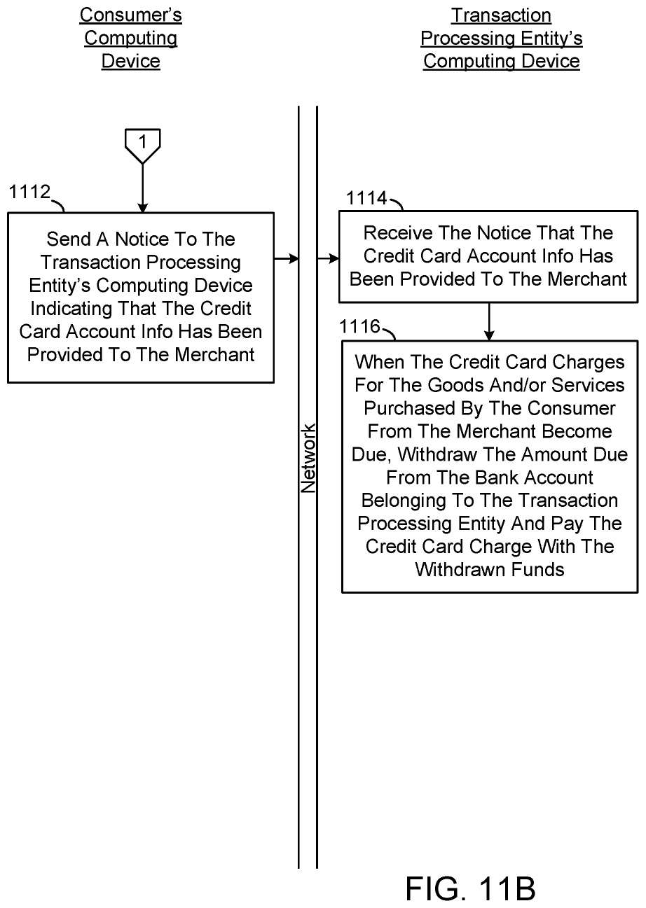

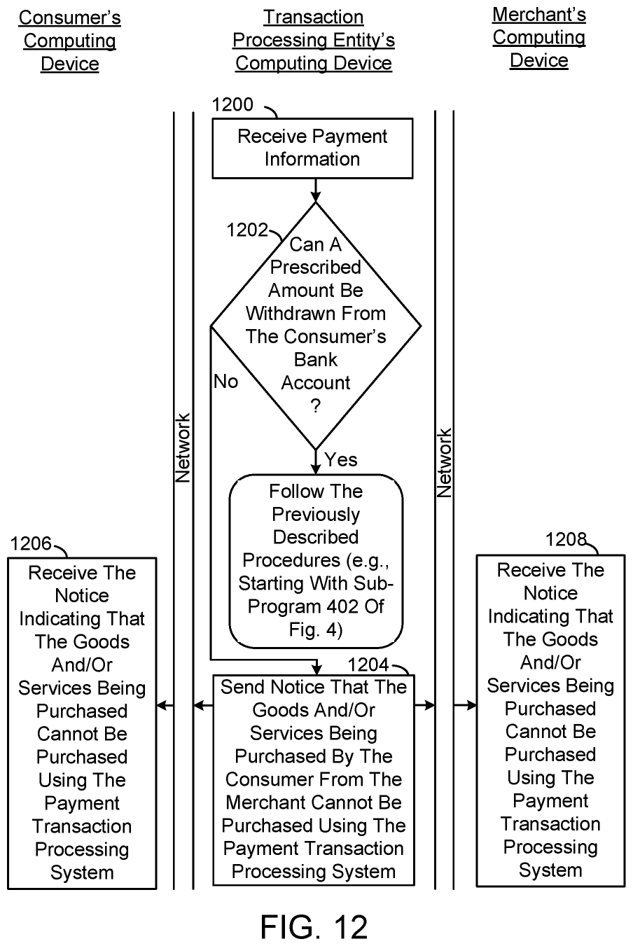

More particularly, in one implementation illustrated in FIGS. 11A-B, a payment information sub-program 1100 associated with the payment transaction facilitation computer program running on the transaction processing entity's computing device receives payment information from the payment transaction facilitation computer program running on a consumer's computing device. A payment withdrawal sub-program 1102 associated with the payment transaction facilitation computer program running on the transaction processing entity's computing device (or associated with the payment transaction facilitation computer program running on the consumer's computing device in the alternate push implementation—not shown in FIG. 11A) is then employed to coordinate the withdrawal of an amount up to the amount of the payment from a bank account belonging to the consumer, and a payment deposit sub-program 1104 is employed to coordinate the deposit of the withdrawn amount into a bank account belonging to the transaction processing entity. The withdrawn amount is the payment amount unless, as in one implementation, a consumer incentive award is held back so that an amount less than the payment amount is withdrawn. A credit card sub-program 1106 associated with the payment transaction facilitation computer program running on the transaction processing entity's computing device provides credit card account information (such as the credit card number, or a virtual number, QR code or other token, among other data) associated with the transaction processing entity to the payment transaction facilitation computer program running on the consumer's computing device, and a credit card receipt sub-program 1108 associated with the payment transaction facilitation computer program running on the consumer's computing device receives the credit card account information. It is noted that interchange fees generally paid to the bank that issued the credit card account to the transaction processing entity via the conventional interchange fee process can have an arrangement with the transaction processing entity to pay the entity a fee amounting to all or part of an interchange fee. The credit card account information is then provided to the merchant in a conventional manner via a credit card submission sub-program 1110 associated with the payment transaction facilitation computer program running on the consumer's computing device. A credit card notification sub-program 1112 associated with the payment transaction facilitation computer program running on the consumer's computing device then sends a notification to the transaction processing entity's computing device indicating that the credit card account information associated with the transaction processing entity has been provided to the merchant. A credit card notification receipt sub-program 1114 associated with the payment transaction facilitation computer program running on the transaction processing entity's computing device receives the credit card notification. Next, when the credit card charges for the goods and/or services purchased by the consumer from the merchant become due, a credit card payment sub-program 1116 is employed to withdraw the amount due from the bank account belonging to the transaction processing entity and paying the credit card charge with the withdrawn funds.

### 1.2.5 Insufficient Funds Notification

In one implementation of the payment transaction processing system, the previously described operations are modified to inform the consumer and merchant via their payment transaction facilitation computer programs that sufficient funds cannot be withdrawn for the consumer's bank account to cover the payment amount (less an incentive award if applicable), and so the sales transaction cannot be completed using the payment transaction processing system. More particularly, in one implementation illustrated in FIG. 12, a payment information sub-program 1200 receives payment information from the payment transaction facilitation computer program running on a consumer's computing device, or a merchant payment transaction facilitation computer program running on a merchant's computing device, or both. This payment information is gathered and provided via one of the procedures described previously. A sufficient funds sub-program 1202 associated with the payment transaction facilitation computer program running on the transaction processing entity's computing device is then used to determine if a prescribed amount up to the amount of the payment can be withdrawn from the consumer's bank account. In this implementation, the prescribed amount is the payment amount or the payment amount less the amount of a consumer incentive award. Whenever it is determined that the prescribed amount is not withdrawable from the consumer's bank, an insufficient funds notice sub-program 1204 associated with the payment transaction facilitation computer program running on the transaction processing entity's computing device informs the consumer via an insufficient funds notice receipt sub-program 1206 associated with the transaction facilitation computer program running on a consumer's computing device, and the merchant via an insufficient funds notice receipt sub-program 1208 associated with the transaction facilitation computer program running on a merchant's computing device, that the goods and/or services being purchased by the consumer from the merchant cannot be purchased using the payment transaction processing system. However, whenever it is determined that the prescribed amount is withdrawable from the consumer's bank account, the previously described procedures are followed (e.g., starting with the payment withdrawal sub-program 402).

### 1.2.6 Excessive Interbank Transfer Fees Notification

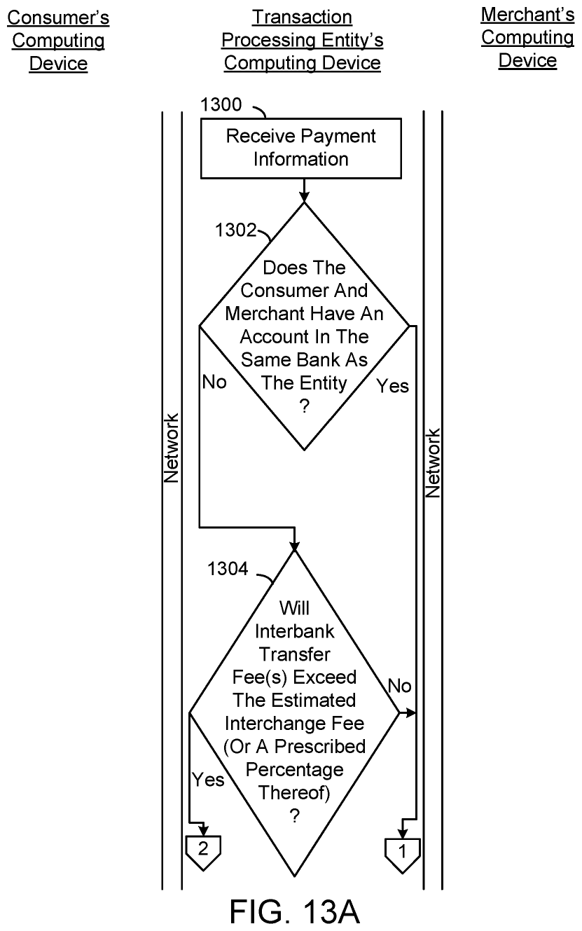

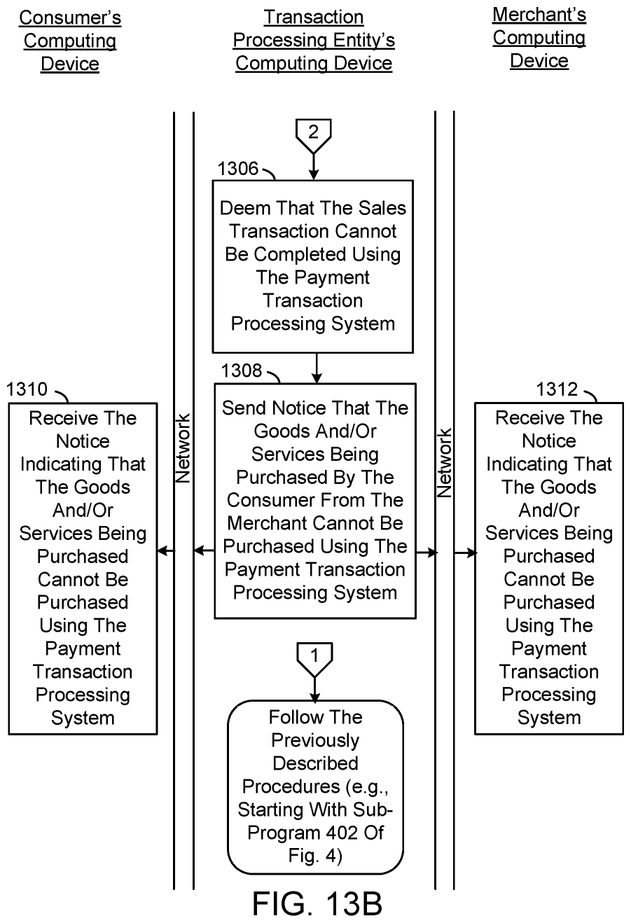

While the foregoing payment transaction where the transaction processing entity, merchant and consumer all have accounts in the same bank, can be the fastest, least risky and most profitable for all the parties, the payment transaction processing system implementations described herein are still advantages even if the consumer, or merchant, of both do not have accounts in the same bank as the transaction processing entity. More particularly, in the case of the consumer having an account at a different bank, the payment amount can be withdrawn from the consumer's bank account by the payment transaction facilitation computer program running on the consumer's computing device and sent to the transaction processing entity's bank account via a interbank transfer system associated with the consumer's bank. Similarly, in the case of the merchant having an account at a different bank, the transaction processing entity can send the payment amount less fees to the merchant's bank account at a different bank via the interbank transfer system of the transaction processing entity's bank. However, there may be bank fees charged by the bank or a 3^{rd} party facilitating the transfer, and the transfer process can add time to the sales transaction. Even so, it is believed that the transfer fees incurred would be significantly less than the interchange fees associated with a corresponding credit card or debit card transaction. As such, the transaction processing entity could still charge a processing fee to the merchant that would be less the interchange fees (thereby benefiting the merchant), but large enough to cover the added bank transfer fees. More particularly, in one implementation illustrated in FIGS. 13A-B, a payment information sub-program 1300 receives payment information from the payment transaction facilitation computer program running on a consumer's computing device, or a merchant payment transaction facilitation computer program running on a merchant's computing device, or both. This payment information is gathered and provided via one of the procedures described previously. A common bank sub-program 1302 associated with the payment transaction facilitation computer program running on the transaction processing entity's computing device uses the payment information to determine if the consumer and merchant involved in the payment transaction have an account at the same bank as the entity. If the consumer and merchant do not have an account at the same bank as the transaction processing entity, then an interbank transfer cost sub-program 1304 associated with the payment transaction facilitation computer program running on the transaction processing entity's computing device determines if any fees associated with the required interbank transfer(s) will exceed the estimated interchange fee typically charged for the same purchase using a credit or debit card, or will exceed a prescribed percentage of the estimated interchange fee associated with the purchase. If it is determined that the interbank transfer fees will exceed the estimated interchange fee (or the prescribed percentage thereof), then a interbank transfer sub-program 1306 associated with the payment transaction facilitation computer program running on the transaction processing entity's computing device deems that the sales transaction cannot be completed using the payment transaction processing system. Whenever it is deemed that the sales transaction cannot be completed using the payment transaction processing system, a payment transaction denial notice sub-program 1308 associated with the payment transaction facilitation computer program running on the transaction processing entity's computing device informs the consumer via a payment transaction denial notice receipt sub-program 1310 associated with the transaction facilitation computer program running on a consumer's computing device, and the merchant via a payment transaction denial notice receipt sub-program 1312 associated with the transaction facilitation computer program running on a merchant's computing device, that the goods and/or services being purchased by the consumer from the merchant cannot be purchased using the payment transaction processing system. It is noted that if it is deemed that the sales transaction cannot be completed using the payment transaction processing system, then the consumer can be invited to input their regular credit or debit card information and the payment can be processed through the regular payment cycle. In this way, the system can handle the old traditional processing too without having to force the merchant or the consumer to switch to another system in the above-mentioned case. However, whenever it is determined that the consumer and merchant both have an account at the same bank as the transaction processing entity, or that the interbank transfer fees will not exceed the estimated interchange fee (or the prescribed percentage thereof), the previously described procedures are followed (e.g., starting with the payment withdrawal sub-program 402 in FIG. 4).

### 2.0 Other Implementations

While the payment transaction processing system has been described by specific reference to implementations thereof, it is understood that variations and modifications thereof can be made without departing from the true spirit and scope of the payment transaction processing system.

It is further noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

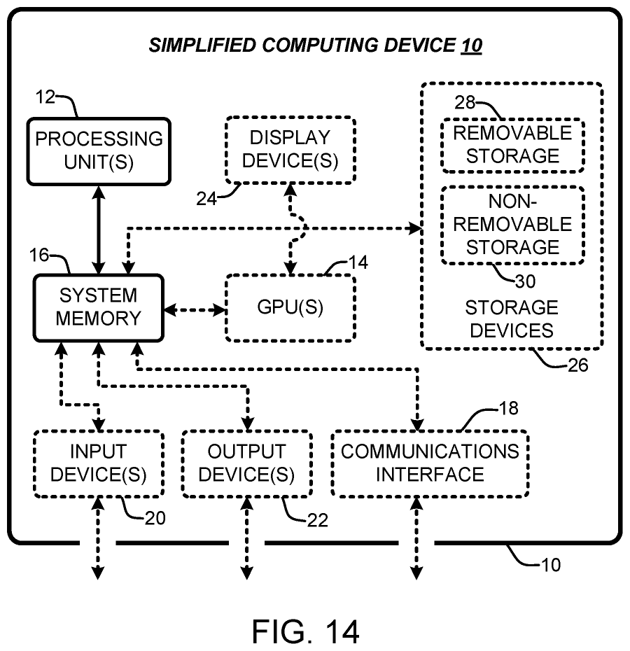

The payment transaction processing system implementations described herein are operational within numerous types of general purpose or special purpose computing system environments or configurations. FIG. 14 illustrates a simplified example of a general-purpose computer system on which various implementations and elements of the payment transaction processing system, as described herein, may be implemented. It is noted that any boxes that are represented by broken or dashed lines in the simplified computing device 10 shown in FIG. 14 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the payment transaction processing system implementations described herein, the device should have a sufficient computational capability and system memory to enable basic computational operations. In particular, the computational capability of the simplified computing device 10 shown in FIG. 14 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIVV) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the payment transaction processing system implementations described herein, including input, output, control, feedback, and response to one or more users or other devices or systems associated with the payment transaction processing system implementations, are enabled by a variety of Natural User Interface (NUI) scenarios. The NUI techniques and scenarios enabled by the payment transaction processing system implementations include, but are not limited to, interface technologies that allow one or more users user to interact with the payment transaction processing system implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the payment transaction processing system implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the payment transaction processing system implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 14 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various payment transaction processing system implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The payment transaction processing system implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The payment transaction processing system implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for facilitating a payment transaction, comprising:
a payment transaction facilitator comprising one or more computing devices associated with a transaction processing entity, and a payment transaction facilitation computer program having a plurality of sub-programs executable by said computing device or devices, wherein the sub-programs configure said computing device or devices to,
receive payment information from a payment transaction facilitation computer program running on a consumer's computing device, or a payment transaction facilitation computer program running on a merchant's computing device, or both, said payment information comprising at least the consumer's identity, the merchant's identity and the payment for the goods or services being purchased by the consumer from the merchant,
withdraw an amount up to the amount of the payment from a bank account belonging to the consumer, using the payment transaction facilitation computer program running on the one or more computing devices associated with the transaction processing entity, and deposit the withdrawn amount into a bank account belonging to the transaction processing entity, using the payment transaction facilitation computer program running on the one or more computing devices associated with the transaction processing entity, and
withdraw the payment amount less a transaction fee which is charged to the merchant by the transaction processing entity from the transaction processing entity's bank account for facilitating the sales transaction, using the payment transaction facilitation computer program running on the one or more computing devices associated with the transaction processing entity, and deposit the payment amount less the transaction fee into a bank account belonging to the merchant, using the payment transaction facilitation computer program running on the one or more computing devices associated with the transaction processing entity, and wherein
the consumer's bank account, the merchant's bank account and the transaction processing entity's bank account are associated with the same bank, and wherein said withdrawing and depositing of the amount up to the amount of the payment is accomplished via an intrabank transfer system associated with the bank, and wherein said withdrawing and depositing of the payment amount less the transaction fee is accomplished via the intrabank transfer system.

2. The system of claim 1, further comprising a sub-program for sending a notification from the transaction processing entity's computing device to the merchant's computing device indicating that the payment amount less the transaction fee has been deposited into the merchant's bank account.

3. The system of claim 1, wherein the consumer's computing device comprises a short distance wireless communication capability, and wherein the merchant's computing device comprises the same short distance wireless communication capability, and wherein during a point of sale transaction in which the merchant's computing device and the consumer's computing device are within each other's short distance wireless communication range, the computing devices are in communication with each other.

4. The system of claim 3, wherein the merchant's computing device comprises a payment terminal.

5. The system of claim 1, wherein said purchase of goods or services by the consumer from the merchant is an online payment transaction conducted over a computer network, and wherein the merchant's computing device comprises a server or servers.

6. The system of claim 1, wherein the sub-program for receiving payment information from the payment transaction facilitation computer program running on the consumer's computing device, or the payment transaction facilitation computer program running on the merchant's computing device, or both, comprises receiving at least the consumer's identity from the payment transaction facilitation computer program running on the consumer's computing device.

7. The system of claim 1, wherein the sub-program for receiving payment information from the payment transaction facilitation computer program running on the consumer's computing device, or the payment transaction facilitation computer program running on the merchant's computing device, or both, comprises receiving the consumer's identity, the merchant's identity and the payment for the goods or services being purchased by the consumer from the merchant, from the payment transaction facilitation computer program running on the consumer's computing device, wherein the merchant's identity and the payment for the goods or services being purchased is provided to the payment transaction facilitation computer program running on the consumer's computing device by the payment transaction facilitation computer program running on the merchant's computing device via a communication link between the consumer's computing device and the merchant's computing device.

8. The system of claim 1, wherein the sub-program for receiving payment information from the payment transaction facilitation computer program running on the consumer's computing device, or the payment transaction facilitation computer program running on the merchant's computing device, or both, comprises receiving at least the merchant's identity and the payment for the goods or services being purchased by the consumer from the merchant, from the payment transaction facilitation computer program running on the merchant's computing device.

9. The system of claim 1, wherein the sub-program for receiving payment information from the payment transaction facilitation computer program running on the consumer's computing device, or the payment transaction facilitation computer program running on the merchant's computing device, or both, comprises receiving the consumer's identity, the merchant's identity and the payment for the goods or services being purchased by the consumer from the merchant, from the payment transaction facilitation computer program running on the merchant's computing device, wherein the consumer's identity is provided to the payment transaction facilitation computer program running on the merchant's computing device by the payment transaction facilitation computer program running on the consumer's computing device via a communication link between the merchant's computing device and the consumer's computing device.

10. The system of claim 1, wherein the sub-program for withdrawing an amount up to the amount of the payment from a bank account belonging to the consumer comprises withdrawing the entire amount of the payment, and wherein the payment transaction facilitation computer program further comprising a sub-program for withdrawing a consumer incentive award amount from the transaction processing entity's bank account, and depositing the withdrawn consumer incentive award amount into the consumer's bank account.

11. The system of claim 1, wherein the sub-program for withdrawing an amount up to the amount of the payment from a bank account belonging to the consumer comprises withdrawing the amount of the payment less a consumer incentive award amount.

12. The system of claim 1, further comprising a sub-program for receiving a notice from the payment transaction facilitation computer program running on a merchant's computing device indicating that the consumer has provided credit or debit card account information as an alternate payment option, and after performing the sub-program of depositing the payment amount less the transaction fee into the merchant's bank account, sending a notice to the payment transaction facilitation computer program running on the merchant's computing device indicating that the payment amount less the transaction fee has been deposited into the merchant's bank account and that a payment using the alternate payment option is not necessary.

13. A system for facilitating a payment transaction, comprising:
a payment transaction facilitator comprising one or more computing devices associated with a transaction processing entity, and a payment transaction facilitation computer program having a plurality of sub-programs executable by said computing device or devices, wherein the sub-programs configure said computing device or devices to,
receive payment information from a payment transaction facilitation computer program running on a consumer's computing device, or a payment transaction facilitation computer program running on a merchant's computing device, or both, said payment information comprising at least the consumer's identity, the merchant's identity and the payment for the goods or services being purchased by the consumer from the merchant,
receive a notice from the payment transaction facilitation computer program running on a consumer's computing device that an amount up to the amount of the payment has been deposited into a bank account belonging to the transaction processing entity, and
withdraw the payment amount less a transaction fee which is charged to the merchant by the transaction processing entity from the transaction processing entity's bank account for facilitating the sales transaction, using the payment transaction facilitation computer program running on the one or more computing devices associated with the transaction processing entity, and deposit the payment amount less the transaction fee into a bank account belonging to the merchant, using the payment transaction facilitation computer program running on the one or more computing devices associated with the transaction processing entity, and wherein
a bank account belonging to the consumer, the merchant's bank account and the transaction processing entity's bank account are associated with the same bank, and wherein said depositing of the amount up to the amount of the payment into the transaction processing entity's bank account is accomplished via an intrabank transfer system associated with the bank, and wherein said withdrawing and depositing of the payment amount less the transaction fee is accomplished via the intrabank transfer system.

14. The system of claim 13, further comprising a sub-program for sending a notification from the transaction processing entity's computing device to the merchant's computing device indicating that the payment amount less the transaction fee has been deposited into the merchant's bank account.

15. The system of claim 13, wherein said deposit of the amount up to the amount of the payment to the transaction processing entity's bank account comprises a deposit of the entire amount of the payment, and wherein the payment transaction facilitation computer program further comprising a sub-program for withdrawing a consumer incentive award amount from the transaction processing entity's bank account, and depositing the withdrawn consumer incentive award amount into a bank account belonging to the consumer.

16. The system of claim 13, wherein said deposit of the amount up to the amount of the payment to the transaction processing entity's bank account comprises a deposit of the amount of the payment less a consumer incentive award amount.

17. The system of claim 13, further comprising a sub-program for receiving a notice from the payment transaction facilitation computer program running on a merchant's computing device indicating that the consumer has provided credit card account information as an alternate payment option, and after performing the sub-program of depositing the payment amount less the transaction fee into the merchant's bank account, sending a notice to the payment transaction facilitation computer program running on the merchant's computing device indicating that the payment amount less the transaction fee has been deposited into the merchant's bank account and that a payment via the alternate payment option is not necessary.

18. A system for facilitating a payment transaction, comprising:
a payment transaction facilitator comprising one or more computing devices associated with a transaction processing entity, and a payment transaction facilitation computer program having a plurality of sub-programs executable by said computing device or devices, wherein the sub-programs configure said computing device or devices to,
receive payment information from a payment transaction facilitation computer program running on a consumer's computing device, or a payment transaction facilitation computer program running on a merchant's computing device, or both, said payment information comprising at least the consumer's identity, the merchant's identity and the payment for the goods or services being purchased by the consumer from the merchant,
determine if a prescribed amount up to the amount of the payment can be withdrawn from a bank account belonging to the consumer,
whenever the prescribed amount is not withdrawable from the consumer's bank, informing the consumer via the payment transaction facilitation computer program running on a consumer's computing device, and the merchant via the payment transaction facilitation computer program running on a merchant's computing device, that the goods or services being purchased by the consumer from the merchant cannot be purchased using the payment transaction facilitator,
whenever the prescribed amount is withdrawable from the consumer's bank, withdraw an amount up to the amount of the payment from a bank account belonging to the consumer, using the payment transaction facilitation computer program running on the one or more computing devices associated with the transaction processing entity, and deposit the withdrawn amount into a bank account belonging to the transaction processing entity, using the payment transaction facilitation computer program running on the one or more computing devices associated with the transaction processing entity, and
withdraw the payment amount less a transaction fee which is charged to the merchant by the transaction processing entity from the transaction processing entity's bank account for facilitating the sales transaction, using the payment transaction facilitation computer program running on the one or more computing devices associated with the transaction processing entity, and deposit the payment amount less the transaction fee into a bank account belonging to the merchant, using the payment transaction facilitation computer program running on the one or more computing devices associated with the transaction processing entity, and wherein
the consumer's bank account, the merchant's bank account and the transaction processing entity's bank account are associated with the same bank, and wherein said withdrawing and depositing of the amount up to the amount of the payment is accomplished via an intrabank transfer system associated with the bank, and wherein said withdrawing and depositing of the payment amount less the transaction fee is accomplished via the intrabank transfer system.

19. A system for facilitating a payment transaction, comprising:
a payment transaction facilitator comprising one or more computing devices associated with a transaction processing entity, and a payment transaction facilitation computer program having a plurality of sub-programs executable by said computing device or devices, wherein the sub-programs configure said computing device or devices to,
receive payment information from a payment transaction facilitation computer program running on a consumer's computing device, or a payment transaction facilitation computer program running on a merchant's computing device, or both, said payment information comprising at least the consumer's identity, the merchant's identity and the payment for the goods or services being purchased by the consumer from the merchant,
determine if the consumer and merchant involved in the payment transaction have an account at the same bank as the transaction processing entity,
whenever the consumer and merchant involved in the payment transaction do not both have an account at the same bank as the transaction processing entity, determine if fees associated with interbank transfer or transfers will exceed an estimated interchange fee typically charged for the same purchase using a credit or debit card, or will exceed a prescribed percentage of the estimated interchange fee associated with the purchase,
whenever it is determined that the interbank transfer fees will exceed the estimated interchange fee, or exceed the prescribed percentage of the estimated interchange fee,
deem that the sales transaction cannot be completed using the payment transaction facilitator, and
inform the consumer via the payment transaction facilitation computer program running on a consumer's computing device, and the merchant via the payment transaction facilitation computer program running on a merchant's computing device, that the goods or services being purchased by the consumer from the merchant cannot be purchased using the payment transaction facilitator,
whenever the consumer and merchant involved in the payment transaction do have an account at the same bank as the transaction processing entity, or whenever the consumer and merchant involved in the payment transaction do not both have an account at the same bank as the transaction processing entity but the interbank transfer fees will not exceed the estimated interchange fee, or not exceed the prescribed percentage of the estimated interchange fee,
withdraw an amount up to the amount of the payment from a bank account belonging to the consumer, using the payment transaction facilitation computer program running on the one or more computing devices associated with the transaction processing entity, and deposit the withdrawn amount into a bank account belonging to the transaction processing entity, using the payment transaction facilitation computer program running on the one or more computing devices associated with the transaction processing entity, and
withdraw the payment amount less a transaction fee which is charged to the merchant by the transaction processing entity from the transaction processing entity's bank account for facilitating the sales transaction, using the payment transaction facilitation computer program running on the one or more computing devices associated with the transaction processing entity, and deposit the payment amount less the transaction fee into a bank account belonging to the merchant, using the payment transaction facilitation computer program running on the one or more computing devices associated with the transaction processing entity, and wherein whenever
the consumer's bank account, the merchant's bank account and the transaction processing entity's bank account are associated with the same bank, said withdrawing and depositing of the amount up to the amount of the payment is accomplished via an intrabank transfer system associated with the bank, and said withdrawing and depositing of the payment amount less the transaction fee is accomplished via the intrabank transfer system.
